(19) United States
(12) Patent Application Publication
(10) Pub. No.: US 2024/0363996 A1
(43) Pub. Date: Oct. 31, 2024

(54) WEARABLE ELECTRONIC DEVICE MOVEMENT, HOUSING, AND WEARABLE ELECTRONIC DEVICE

(71) Applicant: HUAWEI TECHNOLOGIES CO., LTD., Shenzhen, Guangdong (CN)

(72) Inventor: Bing LIU, Xi’an (CN)

(21) Appl. No.: 18/291,868

(22) PCT Filed: Jul. 18, 2022
(86) PCT No.: PCT/CN2022/106258

§ 371 Date: Jan. 24, 2024

(30) Foreign Application Priority Data
Jul. 28, 2021 (CN) 202110859853.0

(51) Int. Cl. H01Q 1/27; G04G 17/08; G04G 21/04; H01Q 1/22

(52) U.S. Cl. CPC H01Q 1/273; G04G 17/08; G04G 21/04; H01Q 1/2291

(57) ABSTRACT

An example wearable electronic device movement includes a metal middle frame and a printed circuit board (PCB) disposed on the metal middle frame. A controller is disposed on the PCB. At least one ground point is provided on the metal middle frame and the ground point is coupled to a ground port on the PCB. At least one feed point is provided on the metal middle frame and is coupled to a radio frequency circuit on the PCB. In response to that the wearable electronic device movement is mounted in mounting space of the housing, the controller is configured to obtain a switch control signal. The controller is configured to control an ON state of at least one of a first switch or a second switch based on the switch control signal, where the first switch is coupled between the at least one ground point and the ground port, and the second switch is coupled between the at least one feed point and the radio frequency circuit.

This application claims priority to Chinese Patent Application No. 202110859853.0, filed with the China National Intellectual Property Administration on Jul. 28, 2021 and entitled “WEARABLE ELECTRONIC DEVICE MOVEMENT, HOUSING, AND WEARABLE ELECTRONIC DEVICE”, which is incorporated herein by reference in its entirety.

### TECHNICAL FIELD

Embodiments of this application relate to the field of electronic devices, and in particular, to a wearable electronic device movement, a housing, and a wearable electronic device.

### BACKGROUND

Currently, there are many electronic products in the communication field, and there are more and more wearable electronic devices such as a smartwatch and a smart band. The devices have become necessities in people's production and life. The smartwatch is used as an example. To enrich appearance experience of the product, a watch manufacturer separately manufactures a watch movement and a housing, and a user mounts the watch movement in the housing. In this way, the watch manufacturer may design a universal watch movement for housings of different appearance designs, so that the user selects the housings of different appearance designs to match the watch movement for use. However, in this product, a metal middle frame of the watch movement is usually used as a watch antenna, for example, an antenna of a global navigation satellite system (global navigation satellite system, GNSS), a global positioning system (navigation satellite timing and ranging global position system, GPS for short), Wi-Fi (wireless fidelity), Bluetooth (Bluetooth, BT), 4G/5G communication, near field communication (near field communication, NFC for short), or another communication standard. In this way, when the watch movement is mounted in the housing, the housing blocks the metal middle frame of the watch movement. Consequently, an antenna signal radiated by the metal middle frame is interfered with.

### SUMMARY

Embodiments of this application provide a wearable electronic device movement, a housing, and a wearable electronic device, to reduce interference caused by the housing blocking a metal middle frame of the watch movement to an antenna signal when the wearable electronic device movement is mounted in the housing.

According to a first aspect, a wearable electronic device movement is provided. The wearable electronic device movement includes a metal middle frame and a printed circuit board (printed circuit board, PCB) disposed on the metal middle frame. A controller is disposed on the PCB. At least one ground point is provided on the metal middle frame, and the ground point is coupled to a ground port on the PCB. At least one feed point is provided on the metal middle frame, and the feed point is coupled to a radio frequency circuit on the PCB. A first switch is coupled between the ground point and the ground port, and/or a second switch is coupled between the feed point and the radio frequency circuit. When the wearable electronic device movement is mounted in mounting space of a housing, the controller is configured to obtain a switch control signal. The controller is configured to control an ON state of at least one first switch and/or an ON state of at least one second switch based on the switch control signal. In this way, because each feed point and each ground point are respectively located at different positions on the metal middle frame, when the different positions on the metal middle frame are connected to the radio frequency circuit based on the ON state of the at least one first switch and/or the ON state of the at least one second switch, antennas with different antenna parameters may be connected to the radio frequency circuit (the antenna parameters mainly refer to a capacitance value and an inductance value of the metal middle frame when the metal middle frame is used as an antenna). In this way, the ON state of the at least one first switch and/or the ON state of the at least one second switch are/is selected to be controlled based on an actual material of the housing, to configure a proper bill of materials (bill of materials, BOM) of the antennas for the radio frequency circuit, so that antenna performance of the metal middle frame is optimal. Therefore, interference caused by the housing blocking the metal middle frame of the watch movement to an antenna signal is reduced.

In a possible implementation, the controller is configured to generate the switch control signal in response to a selection signal triggered by a user based on a material of the housing. For example, a housing mounting interface may be designed based on user experience (user experience, UX). After generating the housing mounting interface in response to trigger of a user on a housing mounting function control displayed on a display screen, a watch may present a drop-down option of the material of the housing to the user. This allows the user to select a material (for example, a metal material, a carbon fiber material, a ceramic material, or a plastic material) of the to-be-mounted housing. A corresponding bill of materials of antennas is preconfigured for different materials of the housing. In response to a selection signal triggered by the user based on a selected material, the controller may generate the switch control signal, and control the ON state of the at least one first switch and/or the ON state of the at least one second switch, to configure a proper bill of materials of antennas for the radio frequency circuit.

In a possible implementation, the wearable electronic device movement further includes: a proximity sensor chip, where the proximity sensor chip is coupled to the metal middle frame, the proximity sensor chip is configured to detect a capacitance value of the metal middle frame; and the controller is configured to generate the switch control signal based on the capacitance value. A position at which the proximity sensor chip is coupled to the metal middle frame may be any position on the metal middle frame. For example, the position may be the foregoing ground point or feed point. Specifically, compared with a scenario in which the housing is not disposed, in this scenario, when the housing is made of an insulating material like the ceramic material or the plastic material, the capacitance value detected by the proximity sensor chip changes. The ceramic material has a high dielectric constant, which is usually 20+ to 30+, and the plastic material has a low dielectric constant, which is usually 2.× to 4.×. The dielectric constants of the ceramic material and the plastic material are greatly different. A capacitance value detected by the proximity sensor chip when the housing is made of the plastic material is lower than a capacitance value detected by the proximity sensor chip when the housing is made of the ceramic material. The material of the housing may be determined based on the capacitance value detected by the proximity sensor chip, and used as a basis for switching the ON state of the at least one first switch and/or the ON state of the at least one second switch. Certainly, when the housing is made of a conductive material like the metal material or the carbon fiber material, if the housing is not connected to the metal middle frame, the housing and the metal middle frame form a capacitor with a large coupling area and a close distance. Therefore, the proximity sensor chip detects a larger capacitance value. When the housing is connected to the metal middle frame, the proximity sensor chip detects a smaller capacitance value. In this way, because the proximity sensor chip can detect the capacitance value, the controller may preconfigure the corresponding bill of materials of antennas for different materials of the housing based on different capacitance values, and generate the switch control signal, to control the ON state of the at least one first switch and/or the ON state of the at least one second switch, and configure the proper bill of materials of antennas for the radio frequency circuit.

In a possible implementation, a connection mechanism is disposed on the metal middle frame. When the wearable electronic device movement is mounted in the mounting space of the housing, the connection mechanism electrically connects the metal middle frame to the housing, and the housing is made of a conductive material. In this way, because the metal middle frame is electrically connected to the housing as a whole by using the connection structure, shielding caused by the housing to the antenna signal can be avoided, and an induced current in a reverse direction of a current of the antenna signal in the metal middle frame cannot be induced or generated on the housing. Therefore, the antenna performance of the metal middle frame is optimal, and the interference caused by the housing blocking the metal middle frame of the watch movement to the antenna signal is reduced.

In a possible implementation, the connection mechanism includes a body and a spring. The body is fastened in the metal middle frame, one end of the spring is connected to the body, and the other end of the spring cambers relative to the body to press against the housing. In this solution, one end of the spring is connected to the body, and the other end cambers relative to the body. Therefore, when the metal middle frame is mounted to the housing after the connection mechanism is fastened to the metal middle frame, because the other end of the spring can effectively press against the housing, and stress exists after the other end of the spring presses against the housing, a good electrical connection can be formed between the metal middle frame and the housing.

In a possible implementation, the body includes a limiting mechanism located at the other end of the spring, and the limiting mechanism limits a camber angle of the other end of the spring. The body is fastened in a mounting groove of the metal middle frame, the spring includes a protrusion close to the other end, the protrusion is away from a direction of the body, and the protrusion protrudes from the mounting groove to press against the housing. The camber angle of the other end of the spring is limited by the limiting mechanism, so that the other end of the spring is protected and is not broken by an external force.

In a possible implementation, an impedance matching circuit is further disposed on the PCB, and the impedance matching circuit is connected between the metal middle frame and the ground port or the radio frequency circuit. In this way, the impedance matching circuit is used to provide the bill of materials of antennas when a housing made of a material (the conductive material) is disposed on the metal middle frame, so that the antenna performance is optimal. Because there is no need to control the switch, power consumption can be reduced as much as possible.

According to a second aspect, a housing is provided. A connection mechanism is disposed inside the housing. When a wearable electronic device movement is detachably mounted in mounting space of the housing, the connection mechanism electrically connects a metal middle frame of the wearable electronic device movement to the housing, and the housing is made of a conductive material. In this way, because the metal middle frame is electrically connected to the housing as a whole by using the connection structure, shielding caused by the housing to an antenna signal can be avoided, and an induced current in a reverse direction of a current of the antenna signal in the metal middle frame cannot be induced or generated on the housing. Therefore, antenna performance of the metal middle frame is optimal, and interference caused by the housing blocking the metal middle frame of the watch movement to the antenna signal is reduced.

In a possible implementation, the connection mechanism includes a body and a spring. The body is fastened in the housing, one end of the spring is connected to the body, and the other end of the spring cambers relative to the body to press against the metal middle frame. In this solution, one end of the spring is connected to the body, and the other end cambers relative to the body. Therefore, when the metal middle frame is mounted to the housing after the connection mechanism is fastened to the housing, because the other end of the spring can effectively press against the metal middle frame, and stress exists after the other end of the spring presses against the metal middle frame, a good electrical connection can be formed between the metal middle frame and the housing.

In a possible implementation, the body includes a limiting mechanism located at the other end of the spring, and the limiting mechanism limits a camber angle of the other end of the spring. The body is fastened in a mounting groove of the housing, the spring includes a protrusion close to the other end, the protrusion is away from a direction of the body, and the protrusion protrudes from the mounting groove to press against the metal middle frame. The camber angle of the other end of the spring is limited by the limiting mechanism, so that the other end of the spring is protected and is not broken by an external force.

According to a third aspect, a wearable electronic device movement is provided. The wearable electronic device movement includes a metal middle frame and a PCB disposed on the metal middle frame. At least one ground point is provided on the metal middle frame, and the ground point is coupled to a ground port on the PCB. At least one feed point is provided on the metal middle frame, and the feed point is coupled to a radio frequency circuit on the PCB. A connection mechanism is disposed on the metal middle frame. When the wearable electronic device movement is mounted in mounting space of a housing, the connection mechanism electrically connects the metal middle frame to the housing, and the housing is made of a conductive material. In this way, because the metal middle frame is electrically connected to the housing as a whole by using the connection structure, shielding caused by the housing to an antenna signal can be avoided, and an induced current in a reverse direction of a current of the antenna signal in the metal middle frame cannot be induced or generated on the housing. Therefore, antenna performance of the metal middle frame is optimal, and interference caused by the housing blocking the metal middle frame of the watch movement to the antenna signal is reduced.

In a possible implementation, the connection mechanism includes a body and a spring. The body is fastened in the metal middle frame, one end of the spring is connected to the body, and the other end of the spring cambers relative to the body to press against the housing. In this solution, one end of the spring is connected to the body, and the other end cambers relative to the body. Therefore, when the metal middle frame is mounted to the housing after the connection mechanism is fastened to the metal middle frame, because the other end of the spring can effectively press against the housing, and stress exists after the other end of the spring presses against the housing, a good electrical connection can be formed between the metal middle frame and the housing.

In a possible implementation, the body includes a limiting mechanism located at the other end of the spring, and the limiting mechanism limits a camber angle of the other end of the spring. The body is fastened in a mounting groove of the metal middle frame, the spring includes a protrusion close to the other end, the protrusion is away from a direction of the body, and the protrusion protrudes from the mounting groove to press against the housing. The camber angle of the other end of the spring is limited by the limiting mechanism, so that the other end of the spring is protected and is not broken by an external force.

According to a fourth aspect, a wearable electronic device is provided, and includes a housing and a wearable electronic device movement that is mounted inside mounting space of the housing. The wearable electronic device movement includes the wearable electronic device movement according to any one of the first aspect or the possible implementations of the first aspect or the wearable electronic device movement according to any one of the third aspect or the possible implementations of the third aspect. The housing includes the housing according to any one of the second aspect or the possible implementations of the second aspect. For technical effects brought by any possible implementation of the fourth aspect, refer to technical effects brought by different implementations of the first aspect to the third aspect. Details are not described herein again.

In a possible implementation, the wearable electronic device further includes a conductive adhesive or a conductive fabric, the conductive adhesive or the conductive fabric is located between the housing and a metal middle frame, and the housing is electrically connected to the metal middle frame through the conductive adhesive or the conductive fabric. In this way, because the metal middle frame is electrically connected to the housing as a whole through the conductive adhesive or the conductive fabric, shielding caused by the housing to an antenna signal can be avoided, and an induced current in a reverse direction of a current of the antenna signal in the metal middle frame cannot be induced or generated on the housing. Therefore, antenna performance of the metal middle frame is optimal, and interference caused by the housing blocking the metal middle frame of the watch movement to the antenna signal is reduced.

### BRIEF DESCRIPTION OF DRAWINGS

FIG. 1 is a schematic diagram of a structure of a wearable electronic device according to an embodiment of this application;

FIG. 2 is a schematic exploded view of a structure of a wearable electronic device according to an embodiment of this application;

FIG. 3 is a schematic sectional view of a partial structure of a wearable electronic device according to an embodiment of this application;

FIG. 4 is a schematic diagram of a structure of mounting a wearable electronic device according to an embodiment of this application;

FIG. 5 is a schematic diagram of a structure of mounting a wearable electronic device according to another embodiment of this application;

FIG. 6 is a schematic diagram of a structure of mounting a wearable electronic device according to still another embodiment of this application;

FIG. 7 is a schematic diagram of a structure of mounting a wearable electronic device according to yet another embodiment of this application;

FIG. 8 is a schematic diagram of a housing mounting interface according to an embodiment of this application;

FIG. 9 is a schematic diagram of a structure of mounting a wearable electronic device according to another embodiment of this application;

FIG. 10 is a diagram of an equivalent circuit of FIG. 9 according to an embodiment of this application;

FIG. 11 is a diagram of an equivalent circuit of FIG. 9 according to another embodiment of this application;

FIG. 12 is a diagram of an equivalent circuit of FIG. 9 according to still another embodiment of this application;

FIG. 13 is a schematic diagram of a structure of mounting a wearable electronic device according to still another embodiment of this application;

FIG. 14 is a schematic sectional view of a partial structure of a wearable electronic device according to another embodiment of this application;

FIG. 15 is a schematic diagram of a structure of a metal middle frame according to an embodiment of this application;

FIG. 16 is a schematic diagram of a structure of a connection mechanism according to an embodiment of this application;

FIG. 17 is a schematic side view of a structure of a connection mechanism according to an embodiment of this application;

FIG. 18 is a schematic diagram of a structure of a connection mechanism according to another embodiment of this application;

FIG. 19 is a schematic side view of a structure of a connection mechanism according to another embodiment of this application;

FIG. 20 is a schematic diagram of mounting a connection mechanism according to an embodiment of this application;

FIG. 21 is a schematic diagram of mounting a connection mechanism according to another embodiment of this application;

FIG. 22 is a schematic diagram of a structure of a housing according to an embodiment of this application;

FIG. 23 is a schematic diagram of mounting a connection mechanism according to still another embodiment of this application;

FIG. 24 is a schematic diagram of mounting a connection mechanism according to yet

another embodiment of this application;

FIG. 25 is a schematic diagram of a structure of mounting a wearable electronic device according to yet another embodiment of this application;

FIG. 26 is a schematic diagram of a structure of mounting a wearable electronic device according to another embodiment of this application; and

FIG. 27 is a schematic diagram of a structure of mounting a wearable electronic device according to still another embodiment of this application.

### DESCRIPTION OF EMBODIMENTS

The following describes technical solutions in embodiments of this application with reference to the accompanying drawings in embodiments of this application. It is clear that the described embodiments are merely some rather than all of embodiments of this application.

In the following, terms “first”, “second”, and the like are merely intended for convenience of description, and shall not be understood as an indication or implication of relative importance or implicit indication of a quantity of indicated technical features. Therefore, a feature limited by “first” or “second” may explicitly or implicitly include one or more features. In the descriptions of this application, unless otherwise specified, “at least one” means one or more, and “a plurality of” means two or more. The term “and/or” describes an association relationship between associated objects, and represents that three relationships may exist. For example, A and/or B may represent the following cases: Only A exists, both A and B exist, and only B exists, where A and B may be singular or plural. “At least one of the following items (pieces)” or a similar expression thereof refers to any combination of these items, including any combination of singular items (pieces) or plural items (pieces). For example, at least one (piece) of a, b, or c may indicate: a, b, c, a and b, a and c, b and c, or a, b, and c, where a, b, and c may be singular or plural. In addition, in embodiments of this application, “above”, “below”, “left”, and “right” are not limited to definitions relative to the schematic placement directions of the devices in the accompanying drawings. It should be understood that these directional terms may be relative concepts, are used for relative description and clarification, and may vary accordingly based on changes of the placement directions of the devices in the accompanying drawings. In this application, unless otherwise explicitly specified and limited, the term “couple” may be a direct connection, or may be an indirect connection through an intermediate medium. In addition, the term “electrical connection” may be a direct electrical connection or an indirect electrical connection through the intermediate medium.

The following describes implementations of embodiments in detail with reference to the accompanying drawings.

Embodiments of this application provide a wearable electronic device. The wearable electronic device includes but is not limited to an electronic device like a band or a watch.

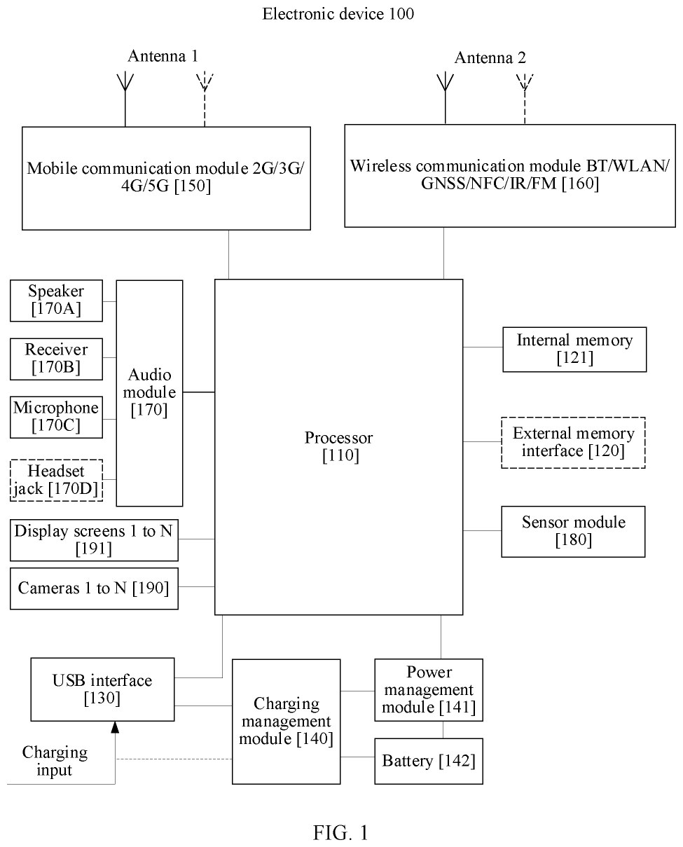

For example, FIG. 1 is a schematic diagram of a structure of an electronic device 100.

The electronic device 100 may include a processor 110, an external memory interface 120, an internal memory 121, a universal serial bus (universal serial bus, USB) interface 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a sensor module 180, a camera 190, a display screen 191, and the like.

It may be understood that the structure shown in this embodiment of the present invention does not constitute a specific limitation on the electronic device 100. In some other embodiments of this application, the electronic device 100 may include more or fewer devices than those shown in the figure, or some devices may be combined, or some devices may be split, or different device arrangements may be used. The devices shown in the figure may be implemented by hardware, software, or a combination of software and hardware.

The processor 110 may include one or more processing units. For example, the processor 110 may include an application processor (application processor, AP), a modem processor, a graphics processing unit (graphics processing unit, GPU), an image signal processor (image signal processor, ISP), a controller, a video codec, a digital signal processor (digital signal processor, DSP), a baseband processor, and/or a neural-network processing unit (neural-network processing unit, NPU). Different processing units may be independent elements, or may be integrated into one or more processors.

A memory may be further disposed in the processor 110, and is configured to store instructions and data. In some embodiments, the memory in the processor 110 is a cache memory. The memory may store instructions or data that has been used or cyclically used by the processor 110. If the processor 110 needs to use the instructions or the data again, the processor may directly invoke the instructions or the data from the memory. This avoids repeated access, reduces waiting time of the processor 110, and improves system efficiency.

In some embodiments, the processor 110 may include one or more interfaces. The interface may include an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identity module (subscriber identity module, SIM) interface, a universal serial bus (universal serial bus, USB) interface, and/or the like.

The charging management module 140 is configured to receive a charging input from a charger. The charger may be a wireless charger, or may be a wired charger. In some embodiments of wired charging, the charging management module 140 may receive a charging input of the wired charger through the USB interface 130. In some embodiments of wireless charging, the charging management module 140 may receive a wireless charging input by using a wireless charging coil of the electronic device 100. When charging the battery 142, the charging management module 140 may further supply power to the electronic device by using the power management module 141.

The power management module 141 is configured to connect the battery 142, the charging management module 140, and the processor 110. The power management module 141 receives an input of the battery 142 and/or the charging management module 140, and supplies power to the processor 110, the internal memory 121, the display screen 191, the camera 190, the wireless communication module 160, and the like. The power management module 141 may be further configured to monitor parameters such as a battery capacity, a battery cycle count, and a battery health status (electric leakage or impedance). In some other embodiments, the power management module 141 may alternatively be disposed in the processor 110. In some other embodiments, the power management module 141 and the charging management module 140 may alternatively be disposed in a same element.

A wireless communication function of the electronic device 100 may be implemented through the antenna 1, the antenna 2, the mobile communication module 150, the wireless communication module 160, the modem processor, the baseband processor, and the like.

The antenna 1 and the antenna 2 are configured to: transmit and receive an electromagnetic wave signal. Each antenna in the electronic device 100 may be configured to cover one or more communication frequency bands. Different antennas may be further multiplexed, to improve antenna utilization. For example, the antenna 1 may be multiplexed as a diversity antenna of a wireless local area network. In some other embodiments, the antenna may be used in combination with a tuning switch.

The mobile communication module 150 may provide a wireless communication solution that is applied to the electronic device 100 and that includes 2G/3G/4G/5G. The mobile communication module 150 may include one or more filters, switches, power amplifiers, low noise amplifiers (low noise amplifiers, LNAs), and the like. The mobile communication module 150 may receive an electromagnetic wave through the antenna 1, perform processing such as filtering or amplification on the received electromagnetic wave, and transmit the electromagnetic wave to the modem processor for demodulation. The mobile communication module 150 may further amplify a signal modulated by the modem processor, and convert the signal into an electromagnetic wave for radiation through the antenna 1. In some embodiments, at least some functional modules of the mobile communication module 150 may be disposed in the processor 110. In some embodiments, at least some functional modules of the mobile communication module 150 may be disposed in a same element as at least some modules of the processor 110.

The modem processor may include a modulator and a demodulator. The modulator is configured to modulate a to-be-sent low-frequency baseband signal into a medium-high frequency signal. The demodulator is configured to demodulate a received electromagnetic wave signal into a low-frequency baseband signal. Then, the demodulator transmits, to the baseband processor for processing, the low-frequency baseband signal obtained through demodulation. The low-frequency baseband signal is processed by the baseband processor and then transmitted to the application processor. The application processor outputs a sound signal by using an audio device (which is not limited to the speaker 170A, the receiver 170B, or the like), or displays an image or a video by using the display screen 191. In some embodiments, the modem processor may be an independent element. In some other embodiments, the modem processor may be independent of the processor 110, and is disposed in a same element as the mobile communication module 150 or another functional module.

The wireless communication module 160 may provide a wireless communication solution that is applied to the electronic device 100 and that includes a wireless local area network (wireless local area network, WLAN) (for example, a wireless fidelity (wireless fidelity, Wi-Fi) network), Bluetooth (Bluetooth, BT), a global navigation satellite system (global navigation satellite system, GNSS), frequency modulation (frequency modulation, FM), a near field communication (near field communication, NFC) technology, an infrared (infrared, IR) technology, or the like. The wireless communication module 160 may be one or more elements integrated with one or more communication processing modules. The wireless communication module 160 receives an electromagnetic wave through the antenna 2, performs frequency modulation and filtering processing on an electromagnetic wave signal, and sends a processed signal to the processor 110. The wireless communication module 160 may further receive a to-be-sent signal from the processor 110, perform frequency modulation and amplification on the signal, and convert the signal into an electromagnetic wave for radiation through the antenna 2.

In some embodiments, in the electronic device 100, the antenna 1 is coupled to the mobile communication module 150, and the antenna 2 is coupled to the wireless communication module 160, so that the electronic device 100 can communicate with a network and another device by using a wireless communication technology. The wireless communication technology may include a global system for mobile communications (global system for mobile communications, GSM), a general packet radio service (general packet radio service, GPRS), code division multiple access (code division multiple access, CDMA), wideband code division multiple access (wideband code division multiple access, WCDMA), time-division code division multiple access (time-division code division multiple access, TD-SCDMA), long term evolution (long term evolution, LTE), BT, a GNSS, a WLAN, NFC, FM, an IR technology, and/or the like. The GNSS may include a global positioning system (global positioning system, GPS), a global navigation satellite system (global navigation satellite system, GLONASS), a BeiDou navigation satellite system (BeiDou navigation satellite system, BDS), a quasi-zenith satellite system (quasi-zenith satellite system, QZSS), and/or a satellite-based augmentation system (satellite-based augmentation system, SBAS).

The electronic device 100 implements a display function by using the GPU, the display screen 191, the application processor, and the like. The GPU is a microprocessor for image processing, and is connected to the display screen 191 and the application processor. The GPU is configured to: perform mathematical and geometric computation, and render an image. The processor 110 may include one or more GPUs that execute program instructions to generate or change display information.

The display screen 191 is configured to display an image, a video, and the like. The display screen 191 includes a display panel. The display panel may be a liquid crystal display (liquid crystal display, LCD), an organic light-emitting diode (organic light-emitting diode, OLED), an active-matrix organic light-emitting diode (active-matrix organic light-emitting diode, AMOLED), a flexible light-emitting diode (flexible light-emitting diode, FLED), a mini-LED, a micro-LED, a micro-OLED, a quantum dot light-emitting diode (quantum dot light emitting-diode, QLED), or the like. In some embodiments, the electronic device 100 may include one or N display screens 191, where N is a positive integer greater than 1.

The electronic device 100 may implement a photographing function by using the ISP, the camera 190, the video codec, the GPU, the display screen 191, the application processor, and the like.

The ISP is configured to process data fed back by the camera 190. For example, during photographing, a shutter is pressed, and light is transmitted to a photosensitive element of the camera through a lens. An optical signal is converted into an electrical signal, and the photosensitive element of the camera transmits the electrical signal to the ISP for processing, to convert the electrical signal into a visible image. The ISP may further perform algorithm optimization on noise, brightness, and complexion of the image. The ISP may further optimize parameters such as exposure and a color temperature of a photographing scenario. In some embodiments, the ISP may be disposed in the camera 190.

The camera 190 is configured to capture a static image or a video. An optical image of an object is generated through the lens, and is projected onto the photosensitive element. The photosensitive element may be a charge coupled device (charge coupled device, CCD) or a complementary metal-oxide-semiconductor (complementary metal-oxide-semiconductor, CMOS) phototransistor. The photosensitive element converts an optical signal into an electrical signal, and then transmits the electrical signal to the ISP to convert the electrical signal into a digital image signal. The ISP outputs the digital image signal to the DSP for processing. The DSP converts the digital image signal into an image signal in a standard format such as RGB or YUV. In some embodiments, the electronic device 100 may include one or N cameras 190, where N is a positive integer greater than 1.

The internal memory 121 may be configured to store one or more computer programs, and the one or more computer programs include instructions. The processor 110 may run the instructions stored in the internal memory 121, to implement various functional applications, data processing, and the like. The internal memory 121 may include a program storage area and a data storage area. The program storage area may store an operating system. The program storage area may further store one or more application programs (such as a gallery and a contact) and the like. The data storage area may store data (such as a photo or a contact) created in a process of using the electronic device 101 and the like. In addition, the internal memory 121 may include a high-speed random access memory, or may include a nonvolatile memory, for example, one or more magnetic disk storage elements, flash memories, or universal flash storage (universal flash storage, UFS). In some other embodiments, the processor 110 runs instructions stored in the internal memory 121 and/or instructions stored in the memory disposed in the processor, to perform various functional applications and data processing of the electronic device 100.

The electronic device 100 may implement an audio function, for example, music playing and recording, through the audio module 170, the speaker 170A, the receiver 170B, the microphone 170C, the headset jack 170D, the application processor, and the like.

The audio module 170 is configured to convert digital audio information into an analog audio signal for output, and is also configured to convert an analog audio input into a digital audio signal. The audio module 170 may be further configured to encode and decode an audio signal. In some embodiments, the audio module 170 may be disposed in the processor 110, or some function modules of the audio module 170 may be disposed in the processor 110.

The speaker 170A, also referred to as a “loudspeaker”, is configured to convert an audio electrical signal into a sound signal. The electronic device 100 may listen to music or answer a hands-free call by using the speaker 170A.

The receiver 170B, also referred to as an “earpiece”, is configured to convert an audio electrical signal into a sound signal. When a call is answered or audio information is listened to by using the electronic device 100, the receiver 170B may be put close to a human ear to listen to a voice.

The microphone 170C, also referred to as a “mike” or a “mic”, is configured to convert a sound signal into an electrical signal. When making a call or sending a voice message, a user may make a sound near the microphone 170C through the mouth of the user, to input a sound signal to the microphone 170C. One or more microphones 170C may be disposed in the electronic device 100. In some other embodiments, two microphones 170C may be disposed in the electronic device 100, to collect a sound signal and further implement a noise reduction function. In some other embodiments, three, four, or more microphones 170C may alternatively be disposed in the electronic device 100, to collect a sound signal, implement noise reduction, and identify a sound source, to implement a directional recording function and the like.

The sensor module 180 may include a pressure sensor, a gyro sensor, a barometric pressure sensor, a magnetic sensor, an acceleration sensor, a distance sensor, a proximity sensor, a fingerprint sensor, a temperature sensor, a touch sensor, an ambient light sensor, a bone conduction sensor, and the like.

The touch sensor is also referred to as a “touch element”. The touch sensor may be disposed on the display screen 191, and the touch sensor and the display screen 191 constitute a touchscreen, which is also referred to as a “touch screen”. The touch sensor is configured to detect a touch operation performed on or near the touch sensor. The touch sensor may transfer the detected touch operation to the application processor, to determine a touch event type. A visual output related to the touch operation may be provided through the display screen. In some other embodiments, a touch panel of a touch sensor array including a plurality of touch sensors may alternatively be disposed on a surface of the display panel in a hanging form. In some other embodiments, the touch sensor and the display screen 191 may alternatively be located in different positions.

In this embodiment of this application, the proximity sensor, the antenna 1, and the antenna 2 may reuse a metal middle frame of a wearable electronic device movement.

In addition, the electronic device may further include one or more devices such as a button, a watch crown, a motor, an indicator, and a subscriber identity module (subscriber identity module, SIM) card interface. This is not limited in this embodiment of this application. Certainly, the foregoing structure is merely an example. In some embodiments, the electronic device may include more or fewer devices than the foregoing devices. For example, in some embodiments, the electronic device may further include the headset jack 170D, the external memory interface 120, and the like. The headset jack 170D is configured to be connected to a wired headset. The headset jack 170D may be the USB interface 130, or may be a 3.5 mm open mobile terminal platform (open mobile terminal platform, OMTP) standard interface or a cellular telecommunications industry association of the USA (cellular telecommunications industry association of the USA, CTIA) standard interface. The external memory interface 120 may be used to connect to an external memory card, for example, a micro SD card, to extend a storage capability of the electronic device 100. The external memory card communicates with the processor 110 through the external memory interface 120, to implement a data storage function. For example, files such as music and videos are stored in the external memory card.

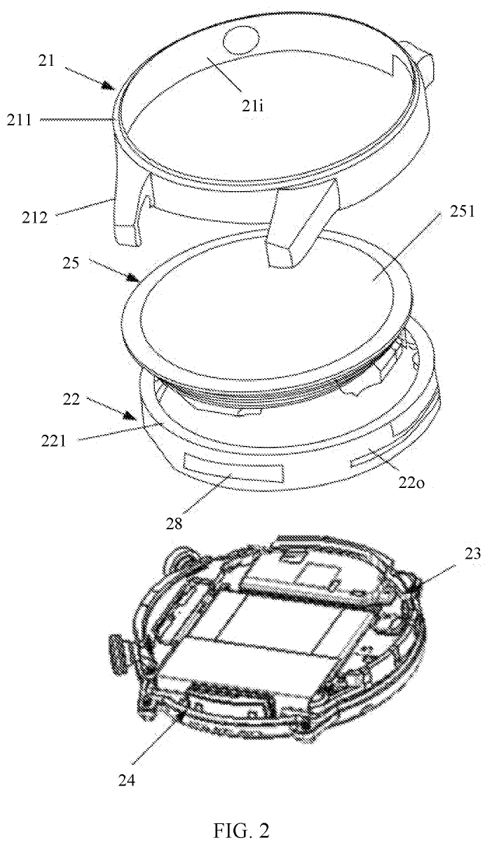

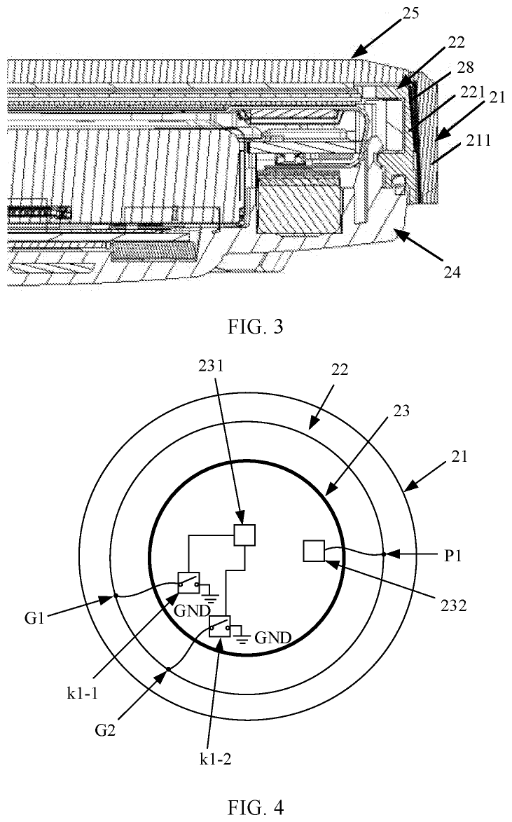

As shown in FIG. 2 and FIG. 3, a watch is used as an example. A structure of a wearable electronic device provided in an embodiment of this application is described as follows.

The wearable electronic device 20 provided in this embodiment of this application includes a housing 21, a metal middle frame 22, a printed circuit board PCB 23, a rear housing 24, and a screen assembly 25 that are assembled together. The housing 21 includes mounting space. The screen assembly 25 and a wearable electronic device movement including the metal middle frame 22, the printed circuit board PCB 23, and the rear housing 24 are mounted inside the mounting space of the housing 21. Specifically, when the housing 21 is made of a hard material like a ceramic, a metal, or a carbon fiber, the wearable electronic device movement may be detachably mounted in the mounting space of the housing 21 through clamping or by using a connecting element like a screw. For another example, when the housing 21 is made of a soft material like a silica gel or a plastic, the wearable electronic device movement may be directly nested in the mounting space of the housing 21. It may be understood that, when the housing 21 needs to be replaced, the wearable electronic device movement may be directly extracted from the inside of the mounting space of the housing 21.

Specifically, in this embodiment, as shown in FIG. 2, the housing 21 includes a ring-shaped housing base 211 and housing extension parts 212 integrally formed with the housing base 211. The metal middle frame 22 includes a ring-shaped middle frame base 221. The two pairs of housing extension parts 212 are respectively extended from the housing base 211 toward both sides. The housing extension parts 212 of the housing 21 are configured to be connected to a watchband. As described above, the wearable electronic device movement may further include a button, a watch crown, and the like. The housing 21 may include a hole for exposing or mounting the button and the watch crown. Therefore, during mounting, the button may be aligned with a hole corresponding to the button on the housing 21, or the watch crown may be aligned with a hole corresponding to the watch crown on the housing 21, to ensure the housing 21 to be accurately aligned with the metal middle frame 22. Certainly, in this embodiment of this application, mounting the button and the watch crown is not limited to being performed before mounting the wearable electronic device movement in the housing 21, or mounting the button and the watch crown is not limited to being performed after mounting the wearable electronic device movement in the housing 21. Certainly, the foregoing is merely a manner of aligning the housing with the metal middle frame. In some embodiments, the housing may alternatively be aligned with the metal middle frame in another manner.

The screen assembly 25 includes a display screen 251. After the wearable electronic device is assembled, the display screen 251 displays information to a user, and the display screen 251 may further be a touchscreen with an information input function, so that the user can interact with the wearable electronic device by using the display screen 251. As shown in FIG. 2 and FIG. 3, the screen assembly 25 is fastened to the metal middle frame 22 above the metal middle frame 22. Specifically, the metal middle frame 22 may be connected to the screen assembly 25 through clamping or bonding or by using a connecting element like a screw. In this embodiment, as shown in FIG. 2 and FIG. 3, the printed circuit board PCB 23 is fastened to the metal middle frame 22 below the metal middle frame 22. The printed circuit board PCB 23 may be disposed on the metal middle frame 22 in a clamping or screw fastening manner. The printed circuit board PCB 23 is used as a carrier of an electronic element and a layout of an electronic device, and is configured to carry the electronic element and the layout in each module shown in FIG. 1. The rear housing 24 is fastened to the metal middle frame 22 below the metal middle frame 22. In this way, the printed circuit board PCB 23 is sealed and protected from below. For example, the rear housing 24 may be connected to the metal middle frame 22 through clamping or by using a connecting element like a screw. In another structure, the printed circuit board PCB 23 may alternatively be integrated with the rear housing 24. For example, the printed circuit board PCB 23 is located in the rear housing 24, and the rear housing 24 is fastened to the metal middle frame 22 below the metal middle frame 22. For example, the rear housing 24 may be connected to the metal middle frame 22 through clamping or by using a connecting element like a screw.

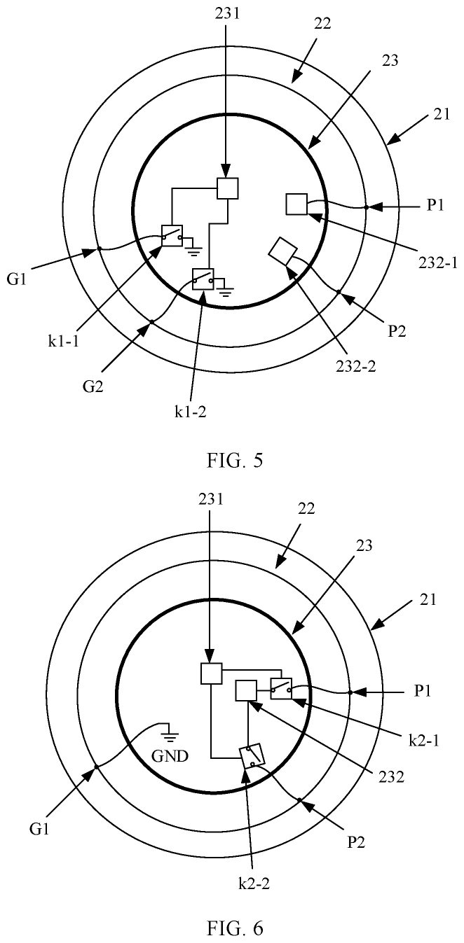

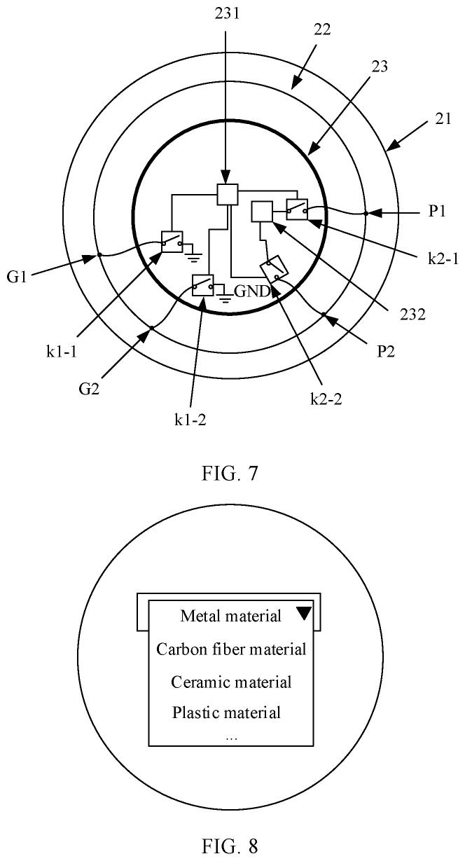

Refer to schematic diagrams shown in FIG. 4, FIG. 5, FIG. 6, and FIG. 7. In this embodiment, a controller 231 is disposed on the PCB 23. The controller 231 may be integrated into a processor 110 for implementation, or may be implemented by using an independent integrated circuit. The metal middle frame 22 is provided with at least one ground point G (ground points G1 and G2 are shown in FIG. 4, FIG. 5, FIG. 6, and FIG. 7) and at least one feed point P (ground points P1 and P2 are shown in FIG. 4, FIG. 5, FIG. 6, and FIG. 7). The ground point G is coupled to a ground port GND on the PCB 23, and the feed point P is coupled to a radio frequency circuit 232 on the PCB 23. Therefore, a ground return path including the radio frequency circuit 232—the feed point P—the metal middle frame 22—the ground point G—the ground port GND is formed. The radio frequency circuit 232 transmits an antenna signal by using the metal middle frame 22. A parameter of an antenna (for example, an inductance value or a capacitance value of the antenna) formed by the metal middle frame 22 is determined based on quantities and positions of ground points G and feed points P. When the wearable electronic device movement includes one or more communication standards such as a global navigation satellite system (global navigation satellite system, GNSS), a global positioning system (navigation satellite timing and ranging global position system, GPS for short), Wi-Fi (wireless fidelity), Bluetooth (Bluetooth, BT), 4G/5G communication, and near field communication (near field communication, NFC for short), the metal middle frame 22 may include one or more feed points P. Each feed point P is correspondingly coupled to a radio frequency circuit of one communication standard. With reference to FIG. 5, for example, the wearable electronic device movement includes radio frequency circuits 232 of two communication standards (in FIG. 5, a radio frequency circuit 232-1 supports a first communication standard, and a radio frequency circuit 232-2 supports a second communication standard). In this case, the radio frequency circuit 232-1 is coupled to the feed point P1, and the radio frequency circuit 232-2 is coupled to the feed point P2. Certainly, the radio frequency circuit of one communication standard may alternatively be coupled to a plurality of feed points P. As shown in FIG. 6, the radio frequency circuit 232 is coupled to the feed point P1 and the feed point P2.

Specifically, when the wearable electronic device movement is detachably mounted in the mounting space of the housing 21, the housing 21 blocks the metal middle frame 22. However, to enrich appearance experience of the product, the housing 21 may be made of different materials, for example, conductive materials such as a metal and a carbon fiber, or insulating materials such as a ceramic, a plastic, and a silica gel. Therefore, when the housing 21 is made of different materials, different interference is caused to the antenna signal transmitted by the metal middle frame 22. For example, when the housing 21 is made of the conductive material like the metal or the carbon fiber, the housing 21 may mainly shield the antenna signal, and an induced current in a reverse direction of a current of the antenna signal in the metal middle frame 22 is induced and generated on the housing 21. When the housing 21 is made of the insulating material like the ceramic, the plastic, or the silica gel, a frequency offset mainly occurs on the antenna signal transmitted by the metal middle frame 22. Therefore, in this embodiment, a first switch k1 may be coupled between the ground point G and the ground port GND (with reference to FIG. 4, FIG. 5, and FIG. 7, a first switch k1-1 is coupled between the ground point G1 and the ground port GND, and a first switch k1-2 is coupled between the ground point G2 and the ground port GND, where the first switch k1-1 and the first switch k1-2 each are not limited to a single-pole single-throw switch, or the first switch k1-1 and the first switch k1-2 each may be a single-pole double-throw switch. For example, when the single-pole double-throw switch is used, a common port of the single-pole double-throw switch is coupled to the ground port GND, and two selection ports of the single-pole double-throw switch are respectively coupled to the ground point G1 and the ground point G2). Additionally/Alternatively, a second switch k2 is coupled between the feed point P and the radio frequency circuit 232 (with reference to FIG. 6 and FIG. 7, a second switch k2-1 is coupled between the feed point P1 and the radio frequency circuit 232, and a second switch k2-2 is coupled between the feed point P2 and the radio frequency circuit 232, where the second switch k2-1 and the second switch k2-2 each are not limited to a single-pole single-throw switch, or the second switch k2-1 and the second switch k2-2 each may be a single-pole double-throw switch. For example, when the single-pole double-throw switch is used, a common port of the single-pole double-throw switch is coupled to the radio frequency circuit 232, and two selection ports of the single-pole double-throw switch are respectively coupled to the feed point P1 and the feed point P2). The controller 231 is configured to obtain a switch control signal. The controller 231 is configured to control an ON state of at least one first switch k1 and/or an ON state of at least one second switch k2 based on the switch control signal. In this way, because each feed point P and each ground point G are respectively located at different positions on the metal middle frame 22, when the different positions on the metal middle frame 22 are connected to the radio frequency circuit 232 based on the ON state of the at least one first switch k1 and/or the ON state of the at least one second switch k2, transmission antennas with different antenna parameters may be connected to the radio frequency circuit 232 (the antenna parameters mainly refer to a capacitance value and an inductance value of the metal middle frame 22 when the metal middle frame 22 is used as an antenna). In this way, the ON state of the at least one first switch k1 and/or the ON state of the at least one second switch k2 are/is selected to be controlled based on an actual material of the housing 21, to configure a proper bill of materials (bill of materials, BOM) of antennas for the radio frequency circuit, so that antenna performance of the metal middle frame is optimal. Therefore, interference caused by the housing blocking the metal middle frame of the watch movement to the antenna signal is reduced.

Specifically, the controller 231 is configured to generate the switch control signal in response to a selection signal triggered by the user based on the material of the housing. For example, a housing mounting interface may be designed based on user experience (user experience, UX). After generating a housing mounting interface as shown in FIG. 8 in response to trigger of the user on a housing mounting function control displayed on the display screen, the watch may present a drop-down option of the material of the housing to the user. This allows the user to select a material (for example, the metal material, the carbon fiber material, the ceramic material, or the plastic material) of the to-be-mounted housing. A corresponding bill of materials of antennas is preconfigured for different materials of the housing. In response to the selection signal triggered by the user based on the selected material, the controller may generate the switch control signal, and control the ON state of the at least one first switch k1 and/or the ON state of the at least one second switch k2, to configure the proper bill of materials of antennas for the radio frequency circuit.

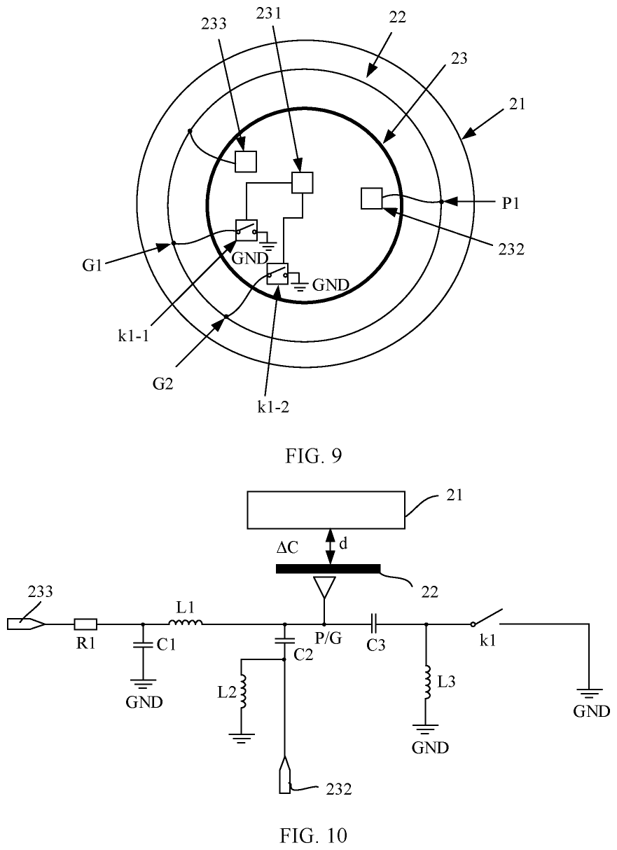

In another embodiment, as shown in FIG. 9, the PCB 23 further includes a proximity sensor chip 233. The proximity sensor chip 233 is coupled to the metal middle frame 22. Certainly, a position at which the proximity sensor chip 233 is coupled to the metal middle frame 22 is not limited in this embodiment. The position at which the proximity sensor chip 233 is coupled to the metal middle frame 22 may be any position on the metal middle frame 22. For example, the position may be the foregoing ground point G or feed point P. The proximity sensor chip 233 is configured to detect a capacitance value of the metal middle frame 22. The controller 231 is configured to generate the switch control signal based on the capacitance value. Specifically, compared with a scenario in which the housing 21 is not disposed, in this scenario, when the housing 21 is made of the insulating material like the ceramic material or the plastic material, the capacitance value detected by the proximity sensor chip 233 changes. The ceramic material has a high dielectric constant, which is usually 20+ to 30+, and the plastic material has a low dielectric constant, which is usually 2.× to 4.×. The dielectric constants of the ceramic material and the plastic material are greatly different. A capacitance value detected by the proximity sensor chip 233 when the housing 21 is made of the plastic material is lower than a capacitance value detected by the proximity sensor chip 233 when the housing 21 is made of the ceramic material. The material of the housing 21 may be determined based on the capacitance value detected by the proximity sensor chip 233, and used as a basis for switching the ON state of the at least one first switch k1 and/or the ON state of the at least one second switch k2. Certainly, when the housing 21 is made of the conductive material like the metal material or the carbon fiber material, if the housing 21 is not connected to the metal middle frame 22, the housing 21 and the metal middle frame 22 form a capacitor with a large coupling area and a close distance. Therefore, the proximity sensor chip 233 detects a larger capacitance value. When the housing 21 is connected to the metal middle frame 22, the proximity sensor chip 233 detects a smaller capacitance value. In this way, because the proximity sensor chip 233 can detect the capacitance value, the controller 231 may preconfigure the corresponding bill of materials of antennas for different materials of the housing based on different capacitance values, and generate the switch control signal, to control the ON state of the at least one first switch k1 and/or the ON state of the at least one second switch k2, and configure the proper bill of materials of antennas for the radio frequency circuit. FIG. 9 mainly shows that the proximity sensor chip 233 is used in the structure of the wearable electronic device shown in FIG. 4. Certainly, it may be understood that, the proximity sensor chip 233 may alternatively be used in the structures of the wearable electronic device shown in FIG. 5, FIG. 6, and FIG. 7. For a function of the proximity sensor chip 233, refer to the descriptions in FIG. 9. Details are not described again. In addition, to reduce energy consumption, the controller is further configured to control the proximity sensor chip 233 to power off after adjusting the ON state of the at least one first switch k1 and/or the ON state of the at least one second switch k2 based on the switch control signal. The proximity sensor chip 233 is mainly configured to detect a capacitance value corresponding to a housing in which a movement is nested. The controller 231 determines a material of the housing based on the capacitance value, and controls an ON state of a switch, to match a proper bill of materials of antennas with the radio frequency circuit. Therefore, the proximity sensor chip 233 may be powered off after an operation of nesting the movement in the housing is completed and the proximity sensor chip 233 completes detecting the capacitance value, to reduce power consumption. Specifically, when the housing needs to be mounted for the wearable electronic device movement, a mounting interface that reminds the user to mount the housing may be opened, and the proximity sensor chip 233 may be woken up simultaneously. After the housing is mounted, the user is reminded to tap to confirm that the mounting is completed. The proximity sensor chip 233 is powered off in response to the confirmation, triggered by the user, that the mounting is completed, or it is set, by default, that the proximity sensor chip 233 is automatically powered off after the proximity sensor chip 233 is woken up for a specific period of time. Certainly, the specific period of time needs to meet a requirement of time duration for the proximity sensor chip 233 to detect the capacitance value of the metal middle frame 22. In addition, if the user clearly feels that signal quality is poor during use of the watch, the user may repeat the foregoing operations.

Certainly, the foregoing mainly describes a solution of determining the material of the housing in a manner in which the proximity sensor chip detects the capacitance value of the metal middle frame. Certainly, in some embodiments, the material of the housing may alternatively be detected by including an identification module in the housing. For example, the identification module may be a magnet, a radio frequency identification (radio frequency identification, RFID), or a color coating. It may be understood that, when the identification module is the magnet, magnets of different magnetic field strengths may be disposed on housings made of different materials. In this way, a magnetic sensor (for example, a Hall effect sensor) may be further disposed on the PCB 23. The controller may determine the material of the housing based on a magnetic field strength detected by the magnetic sensor, and control an ON state of a switch. For another example, when the identification module is the RFID, different RFIDs may be disposed on housings made of different materials. In this way, a near field communication (near field communication, NFC) chip may be further disposed on the PCB 23. The controller may determine the material of the housing based on material information that is stored in the RFID and that is read by the NFC chip, and control an ON state of a switch. For still another example, when the identification module is the color coating, color coatings of different colors may be disposed on housings made of different materials. In this way, a photoelectric sensor may be further disposed on the PCB 23. The controller may determine the material of the housing based on a color of a color coating detected by the photoelectric sensor, and control an ON state of a switch.

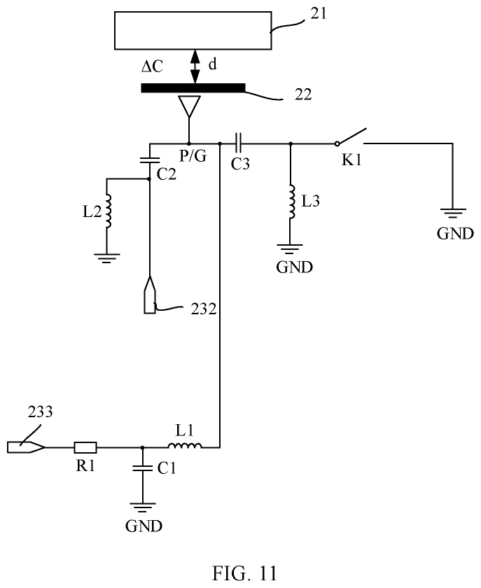

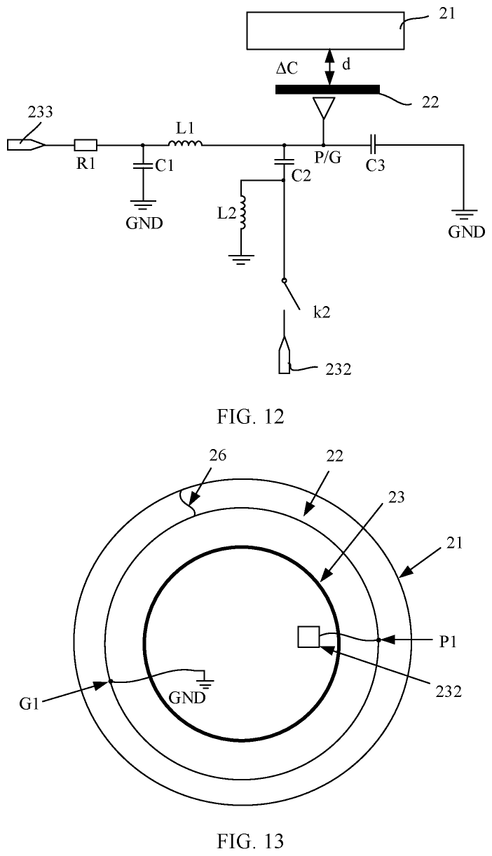

As shown in FIG. 10, FIG. 11, and FIG. 12, diagrams of equivalent circuits of FIG. 9 are described as follows. Usually, a specific capacitance (with a specific capacitance value) exists between the ground and the metal middle frame 22 used as an electrode of a capacitor. When an outer side of the metal middle frame 22 is nested in the housing 21, because the proximity sensor chip 233 adds a voltage to the metal middle frame 22, the metal middle frame 22 is polarized under electrostatic induction. In this way, a closer distance (for example, in FIG. 9, a distance between the metal middle frame 22 and the housing 21 is d) between the housing 21 and the metal middle frame 22 indicates more induced charges detected on the metal middle frame 22, and indicates a larger capacitance value variable AC detected by the proximity sensor chip 233. In the detection process, to avoid a case in which a radio frequency signal output by the radio frequency circuit 232 to the metal middle frame 22 affects a detection result of the proximity sensor chip 233, an isolation inductor L is usually coupled between the proximity sensor chip 233 and the metal middle frame 22. In addition, to avoid a case in which the proximity sensor chip 233 is directly coupled to the radio frequency circuit 232 or is directly short-circuited to the ground through the metal middle frame 22, a direct current blocking capacitor C is usually disposed between the metal middle frame 22, the ground port GND, and the feed point P. In addition, to avoid impact of the radio frequency signal of the radio frequency circuit 232 on the proximity sensor chip 233, the radio frequency circuit 232 is usually connected to the ground port GND by using an inductor. In addition, to avoid impact of a capacitance change of the metal middle frame 22 on the proximity sensor chip 233 when the switch is switched, the switch is usually connected to the ground port GND by using an inductor. Specifically, as shown in FIG. 10, the proximity sensor chip 233 is coupled to the feed point P of the metal middle frame 22, and the switch k1 is connected between the ground point G of the metal middle frame 22 and the ground port GND. A resistor R1 and an inductor L1 are connected in series between the proximity sensor chip 233 and the feed point P, and a proper resistance value is selected for the resistor R1 to suppress noise of the proximity sensor chip 233. A connection between the resistor R1 and the inductor L1 is connected to the ground port GND by using a capacitor C1. A capacitor C2 is coupled between the radio frequency circuit 232 and the feed point P. The radio frequency circuit 232 is further coupled to the ground port by using an inductor L2. The capacitor C2 and the inductor L2 form an isolation network for the radio frequency circuit 232, to avoid the impact of the radio frequency signal of the radio frequency circuit 232 on the proximity sensor chip 233. A capacitor C3 and the switch k1 are connected in series between the ground point G of the metal middle frame 22 and the ground port GND, and a connection between the capacitor C3 and the switch k1 is connected to the ground port GND by using an inductor L3. The capacitor C3 and the inductor L3 form an isolation network for the switch k1, to avoid the impact of the capacitance change of the metal middle frame 22 on the proximity sensor chip 233 when the switch is switched. As shown in FIG. 11, the proximity sensor chip 233 is coupled to the ground point G of the metal middle frame 22, and the switch k1 is connected between the ground point G of the metal middle frame 22 and the ground port GND. A resistor R1 and an inductor L1 are connected in series between the proximity sensor chip 233 and the ground point G, and a proper resistance value is selected for the resistor R1 to suppress noise of the proximity sensor chip 233. A connection between the resistor R1 and the inductor L1 is connected to the ground port GND by using a capacitor C1. A capacitor C2 is coupled between the radio frequency circuit 232 and the feed point P. The radio frequency circuit 232 is further coupled to the ground port GND by using an inductor L2. The C2 and the L2 form an isolation network for the radio frequency circuit 232, to avoid the impact of the radio frequency signal of the radio frequency circuit 232 on the proximity sensor chip 233. A capacitor C3 and the switch k1 are connected in series between the ground point G of the metal middle frame 22 and the ground port GND, and a connection between the capacitor C3 and the switch k1 is connected to the ground port GND by using an inductor L3. The capacitor C3 and the inductor L3 form an isolation network for the switch k1, to avoid the impact of the capacitance change of the metal middle frame 22 on the proximity sensor chip 233 when the switch is switched. As shown in FIG. 12, the proximity sensor chip 233 is coupled to the feed point P of the metal middle frame 22, and the switch k2 is connected between the feed point P of the metal middle frame 22 and the radio frequency circuit 232. A resistor R1 and an inductor L1 are connected in series between the proximity sensor chip 233 and the feed point P, and a proper resistance value is selected for the resistor R1 to suppress noise of the proximity sensor chip 233. A connection between the resistor R1 and the inductor L1 is connected to the ground port GND by using a capacitor C1. The switch k2 and a capacitor C2 are successively connected in series between the radio frequency circuit 232 and the feed point P. The radio frequency circuit 232 is further coupled to the ground port GND by using an inductor L2. The C2 and the L2 form an isolation network for the radio frequency circuit 232 and the switch k2, to avoid the impact of the radio frequency signal of the radio frequency circuit 232 on the proximity sensor chip 233 and the impact of the capacitance change of the metal middle frame 22 on the proximity sensor chip 233 when the switch is switched. A capacitor C3 is connected in series between the ground point G of the metal middle frame 22 and the ground port GND, to avoid a case in which the proximity sensor chip 233 is directly short-circuited to the ground. The capacitor C1 may be replaced with a transient voltage suppressor (transient voltage suppressor, TVS). To improve sensitivity of detecting the capacitance value by the proximity sensor chip 233, the proximity sensor chip 233 is as far away from a heat source element like a power amplifier (power amplifier, PA) on the PCB as possible, to reduce a risk of temperature drift.

It may be understood that the proximity sensor chip 233 and the controller 231 may be integrated into the processor 110 for implementation, or may be implemented by using an independent integrated circuit.

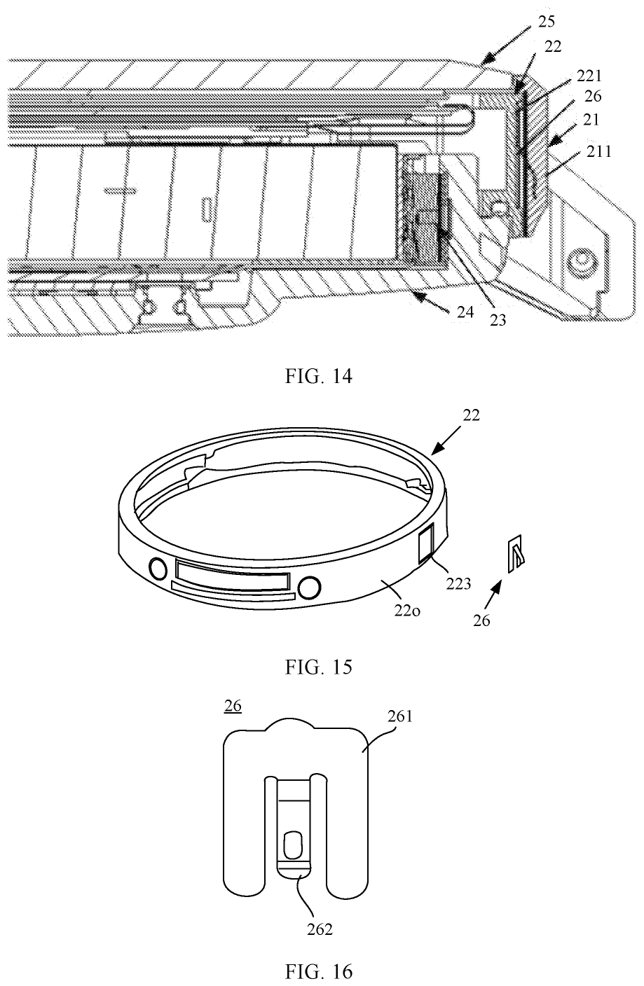

In another embodiment, when the housing 21 is made of the conductive material (for example, the metal or the carbon fiber), as shown in FIG. 13, FIG. 14, and FIG. 15, the provided wearable electronic device movement includes the metal middle frame 22 and the PCB 23 disposed on the metal middle frame 22. At least one ground point G (G1) is provided on the metal middle frame 22, and the ground point G1 is coupled to the ground port GND on the PCB 23. At least one feed point P (P1) is provided on the metal middle frame 22, and the feed point P1 is coupled to the radio frequency circuit 232 on the PCB 23. In addition, a connection structure 26 is disposed on the metal middle frame 22. When the wearable electronic device movement is mounted in the mounting space of the housing 21, the connection mechanism 26 electrically connects the metal middle frame 22 to the housing 21. In this way, because the metal middle frame 22 is electrically connected to the housing 21 as a whole by using the connection structure 26, shielding caused by the housing 21 to the antenna signal can be avoided, and an induced current in a reverse direction of a current of the antenna signal in the metal middle frame 22 cannot be induced or generated on the housing 21. Therefore, antenna performance of the metal middle frame is optimal, and interference caused by the housing blocking the metal middle frame of the watch movement to the antenna signal is reduced. Usually, to ensure a stable connection between the metal middle frame and the housing, in this embodiment of this application, disposing one or more connection structures 26 on the metal middle frame 22 is not limited. Certainly, when a plurality of connection structures 26 are disposed, a specific location of each connection structure is not limited in this embodiment of this application. For example, the connection structures may be uniformly disposed or symmetrically disposed along an outer peripheral surface 220 of the metal middle frame 22.

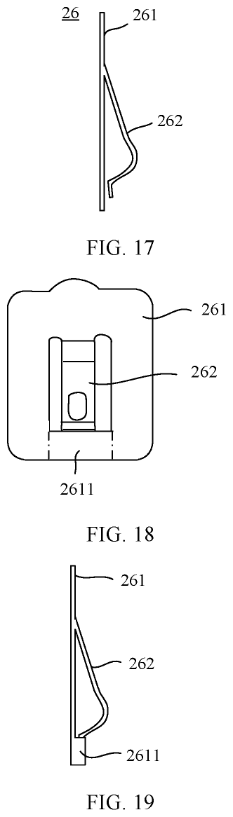

In addition, as shown in FIG. 16 and FIG. 17, the connection mechanism 26 includes a body 261 and a spring 262. The body 261 is fastened in the metal middle frame 22, one end of the spring 262 is connected to the body 261, and the other end of the spring 262 cambers relative to the body 261 to press against the housing 21 (as shown in FIG. 14). In this solution, one end of the spring is connected to the body, and the other end cambers relative to the body. Therefore, when the metal middle frame is mounted to the housing after the connection mechanism is fastened to the metal middle frame, because the other end of the spring can effectively press against the housing, and stress exists after the other end of the spring presses against the housing, a good electrical connection can be formed between the metal middle frame and the housing. In addition, as shown in FIG. 18 and FIG. 19, the body 261 may further include a limiting mechanism 2611 located at the other end of the spring 262, and the limiting mechanism 2611 limits a camber angle of the other end of the spring 262. The body 261 is fastened in a mounting groove 223 (as shown in FIG. 15) of the metal middle frame 22, the spring 262 includes a protrusion close to the other end, the protrusion is away from a direction of the body 261, and the protrusion protrudes from the mounting groove 223 to press against the housing 21. FIG. 20 shows a state of the spring 262 before the housing 21 is mounted on the metal middle frame 22. The camber angle of the other end of the spring 262 is limited by the limiting mechanism 2611, so that the other end of the spring is protected and is not broken by an external force. As shown in FIG. 21, after the housing 21 is mounted on the metal middle frame 22, the protrusion at the other end of the spring 262 presses against the housing 21, to form an electrical connection between the metal middle frame 22 and the housing 21.

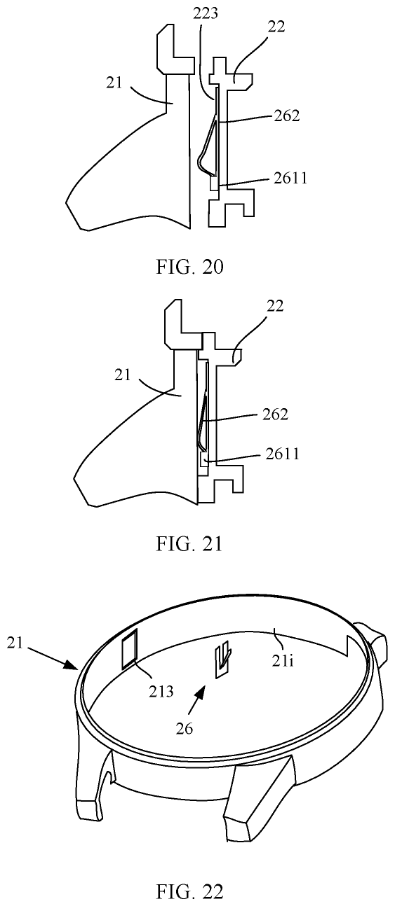

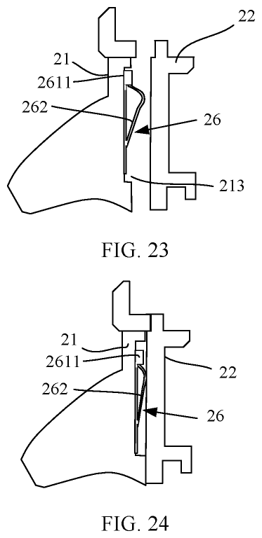

In some examples, the connection mechanism 26 may alternatively be disposed on the housing 21. When the wearable electronic device movement is detachably mounted in the mounting space of the housing 21, the connection mechanism 26 electrically connects the metal middle frame 22 of the wearable electronic device movement to the housing 21, and the housing 21 is made of the conductive material. In this way, because the metal middle frame 22 is electrically connected to the housing 21 as a whole by using the connection structure 26, shielding caused by the housing 21 to the antenna signal can be avoided, and an induced current in a reverse direction of a current of the antenna signal in the metal middle frame 22 cannot be induced or generated on the housing 21. Therefore, antenna performance of the metal middle frame is optimal, and interference caused by the housing blocking the metal middle frame of the watch movement to the antenna signal is reduced. For a specific structure of the connection mechanism, refer to the connection mechanism in FIG. 16 to FIG. 19. The connection mechanism 26 includes the body 261 and the spring 262. The body 261 is fastened in the housing 21. One end of the spring 262 is connected to the body 261, and the other end of the spring 262 cambers relative to the body 261 to press against the metal middle frame 22. In this solution, one end of the spring is connected to the body, and the other end cambers relative to the body. Therefore, when the metal middle frame is mounted to the housing after the connection mechanism is fastened to the housing, because the other end of the spring can effectively press against the metal middle frame, and stress exists after the other end of the spring presses against the metal middle frame, a good electrical connection can be formed between the metal middle frame and the housing. In addition, the body 261 includes the limiting mechanism 2611 located at the other end of the spring 262, and the limiting mechanism 2611 limits the camber angle of the other end of the spring 262. The body 261 is fastened in a mounting groove 213 (as shown in FIG. 22) of the housing 21, the spring 262 includes the protrusion close to the other end, the protrusion is away from the direction of the body 261, and the protrusion protrudes from the mounting groove 213 to press against the metal middle frame 22. FIG. 23 shows a state of the spring 262 before the housing 21 is mounted on the metal middle frame 22. The camber angle of the other end of the spring is limited by the limiting mechanism 2611, so that the other end of the spring is protected and is not broken by an external force. As shown in FIG. 24, after the housing 21 is mounted on the metal middle frame 22, the protrusion at the other end of the spring 262 presses against the metal middle frame 22, to form an electrical connection between the metal middle frame 22 and the housing 21. Usually, to ensure a stable connection between the metal middle frame and the housing, in this embodiment of this application, disposing one or more connection structures 26 on the housing 21 is not limited. Certainly, when a plurality of connection structures 26 are disposed, a specific location of each connection structure is not limited in this embodiment of this application. For example, the connection structures may be uniformly disposed or symmetrically disposed along an inner peripheral surface 21i of the housing 21.

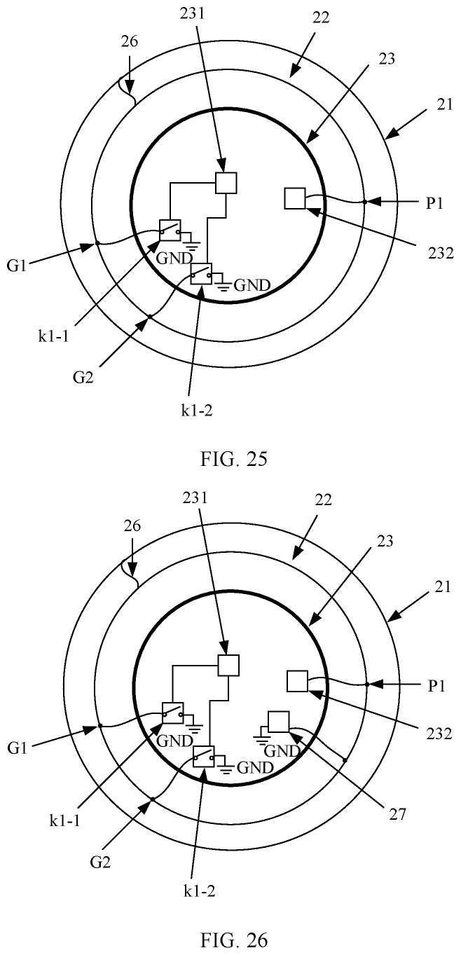

In addition, as shown in FIG. 25, a solution including the foregoing connection structure 26 may also be applied to the solutions corresponding to FIG. 4, FIG. 5, FIG. 6, FIG. 7, and FIG. 9. Certainly, FIG. 26 shows only an example of applying the solution of the connection structure 26 to the foregoing solution of FIG. 4. A difference between FIG. 15 and FIG. 22 lies in that directions of the other ends of the spring 262 are different. Considering that the wearable electronic device movement is usually mounted in the housing 21 below the housing 21, when the spring 262 is disposed on the metal middle frame 22, the other end of the spring 262 is away from a direction of the housing 21, to facilitate mounting and avoid damage to the spring caused by the housing 21 blocking the other end of the spring 262 in a mounting process. Similarly, when the spring 262 is disposed on the housing 21, the other end of the spring 262 is away from a direction of the metal middle frame 22, to facilitate mounting and avoid damage to the spring caused by the metal middle frame 22 blocking the other end of the spring 262 in a mounting process.

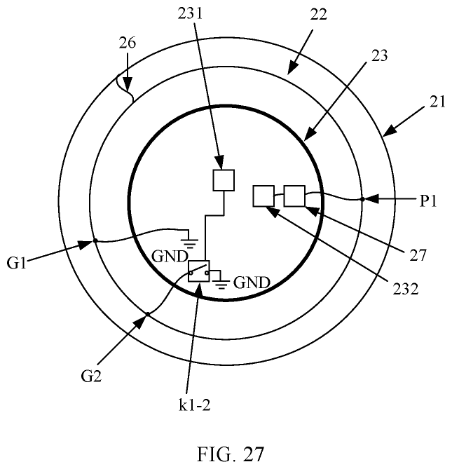

In addition, with reference to FIG. 26 and FIG. 27, an impedance matching circuit 27 is further disposed on the PCB 23. The impedance matching circuit 27 is connected between the metal middle frame 22 and the ground port GND or the radio frequency circuit 232. The impedance matching circuit 27 may include a circuit formed by connecting an inductor and a capacitor. For example, a typical impedance matching circuit includes a capacitor and an inductor. When the impedance matching circuit 27 is disposed between the metal middle frame 22 and the radio frequency circuit 232, the capacitor is connected in series between the metal middle frame 22 and the radio frequency circuit 232, and the inductor is connected in series between the ground port GND and a connection point between the metal middle frame and the capacitor. When the housing 21 is made of a material (for example, the conductive material like the metal material or the carbon fiber material), the metal middle frame 22 is returned to the ground through a fixed path. As shown in FIG. 26, the radio frequency circuit 232 is directly connected to a feed point PI of the metal middle frame 22 on the path (no switch is disposed between the feed point PI and the radio frequency circuit 232). The metal middle frame 22 is directly connected to the ground port GND by using the impedance matching circuit 27. In this way, the impedance matching circuit is used to provide a bill of materials of antennas when a housing made of a material (the conductive material) is disposed on the metal middle frame, so that the antenna performance is optimal. Because there is no need to control the switch, power consumption can be reduced as much as possible. When the housing 21 is made of another material (for example, the conductive material like the ceramic material or the plastic material), the controller controls, based on the switch control signal, the ON state of the at least one first switch and/or the ON state of the at least one second switch. The impedance matching circuit 27 and the switch work simultaneously to return the metal middle frame 22 to the ground. It may be understood that, in this case, the antenna performance of the electronic device depends on both antenna impedance provided by the impedance matching circuit 27 and antenna impedance formed on the metal middle frame by a feed point and/or a ground point selected by the at least one first switch and/or the at least one second switch. Alternatively, when the housing 21 is made of a material (for example, the conductive material like the metal material or the carbon fiber material), the metal middle frame returns to the ground through a fixed path. As shown in FIG. 27, the radio frequency circuit 232 is directly connected to the metal middle frame 22 by using the impedance matching circuit 27 on the path. The metal middle frame 22 is directly connected to the ground port GND by using the ground point G1. In this way, the impedance matching circuit is used to provide a bill of materials of antennas when a housing made of a material (the conductive material) is disposed on the metal middle frame, so that the antenna performance is optimal. Because there is no need to control the switch, power consumption can be reduced as much as possible. When the housing 21 is made of another material (for example, the conductive material like the ceramic material or the plastic material), the controller controls, based on the switch control signal, the ON state of the at least one first switch and/or the ON state of the at least one second switch. The impedance matching circuit 27 and the switch work simultaneously to return the metal middle frame 22 to the ground.

In addition, with reference to FIG. 2, to enable the housing 21 and the metal middle frame 22 to be fastened to each other and implement an electrical connection, in addition to the foregoing connection mechanism in a form of the spring, this may also be implemented by using a conductive adhesive or a conductive fabric. In this embodiment, the wearable electronic device includes a conductive adhesive 28. The conductive adhesive 28 is located between the inner peripheral surface 21i of the housing 21 and the outer peripheral surface 220 of the metal middle frame 22. The conductive adhesive 28 is in contact with the inner peripheral surface 21i of the housing 21. In this way, the housing 21 and the metal middle frame 22 are fastened together by using the conductive adhesive 28, and are also electrically connected by using the conductive adhesive 28. This application does not limit a shape and arrangement of the conductive adhesive 28, provided that the conductive adhesive 28 can implement the foregoing functions. Specifically, although FIG. 2 shows that the conductive adhesive 28 disposed on the metal middle frame 22 is approximately arc-shaped, no limitation is imposed herein. The conductive adhesive 28 may be set to another shape as required, and may be disposed at different parts of the metal middle frame 22. In addition, this application does not limit a substrate material and a conductive component of the conductive adhesive 28, provided that the conductive adhesive 28 can implement the foregoing functions. Specifically, different substrate materials can be selected based on different curing conditions, and the substrate materials may include various plastics, dispersant, additives, and the like. The conductive component of the conductive adhesive 28 may be a conductive material like silver powder, gold powder, copper powder, aluminum powder, zinc powder, nickel powder, carbon powder, or graphite. In addition, the conductive adhesive 28 may be in a form of paste, pulp, or conductive tape. In an optional solution, the conductive adhesive 28 may be replaced with a conductive fabric. The conductive fabric is located between the housing 21 and the metal middle frame 22, and the housing 21 and the metal middle frame 22 are fastened together by using the conductive fabric and are electrically connected. In an optional solution, the housing 21 and the metal middle frame 22 are fastened together by using a bolt and are electrically connected. In addition, the metal middle frame 22 may be electrically connected to a corresponding conductive part (for example, a layout or an electronic element) of the PCB 23 by using a connection post or the like.

Although this application is described with reference to embodiments, in a process of implementing this application that claims protection, a person skilled in the art may understand and implement another variation of the disclosed embodiments by viewing the accompanying drawings, disclosed content, and the appended claims. In the claims, the word “comprising” does not exclude another component or another step, and “a” or “one” does not exclude a case of multiple. Some measures are recorded in dependent claims that are different from each other, but this does not mean that the measures cannot be combined to generate better effect.

Embodiments of this application are described above. The foregoing descriptions are examples, are not exhaustive, and are not limited to the disclosed embodiments. Many modifications and changes are clear to a person of ordinary skill in the art without departing from the scope and spirit of the described embodiments. The selection of terms used in this specification is intended to best explain the principles of embodiments, actual application, or improvements to technologies in the market, or to enable another person of ordinary skill in the art to understand embodiments disclosed in this specification.

1. A wearable electronic device movement comprising a metal middle frame and a printed circuit board (PCB) disposed on the metal middle frame, wherein:
a controller is disposed on the PCB;
at least one ground point is provided on the metal middle frame and is coupled to a ground port on the PCB;
at least one feed point is provided on the metal middle frame and is coupled to a radio frequency circuit on the PCB;
in response to that the wearable electronic device movement is mounted in mounting space of a housing, the controller is configured to obtain a switch control signal; and
the controller is configured to control an ON state of at least one of a first switch or a second switch based on the switch control signal, the first switch being coupled between the at least one ground point and the ground port, the second switch being coupled between the at least one feed point and the radio frequency circuit.

2. The wearable electronic device movement according to claim 1, wherein the controller is configured to generate the switch control signal in response to a selection signal triggered by a user based on a material of the housing.

3. The wearable electronic device movement according to claim 1, further comprising: a proximity sensor chip, wherein the proximity sensor chip is coupled to the metal middle frame;
the proximity sensor chip is configured to detect a capacitance value of the metal middle frame; and
the controller is configured to generate the switch control signal based on the capacitance value.

4. The wearable electronic device movement according to claim 1, wherein a connection mechanism is disposed on the metal middle frame; and in response to that the wearable electronic device movement is mounted in the mounting space of the housing, the connection mechanism electrically connects the metal middle frame to the housing, and the housing is made of a conductive material.

5. The wearable electronic device movement according to claim 4, wherein the connection mechanism comprises a body and a spring, the body is fastened in the metal middle frame, a first end of the spring is connected to the body, and a second end of the spring cambers relative to the body to press against the housing.

6. The wearable electronic device movement according to claim 5, wherein the body comprises a limiting mechanism located at the second end of the spring, the limiting mechanism limits a camber angle of the second end of the spring, the body is fastened in a mounting groove of the metal middle frame, the spring comprises a protrusion close to the second end, the protrusion is away from a direction of the body, and the protrusion protrudes from the mounting groove to press against the housing.

7. The wearable electronic device movement according to claim 1, wherein an impedance matching circuit is further disposed on the PCB, and the impedance matching circuit is connected between the metal middle frame and the ground port or the radio frequency circuit.

8. A housing, wherein a connection mechanism is disposed inside the housing; and in response to that a wearable electronic device movement is detachably mounted in mounting space of the housing, the connection mechanism electrically connects a metal middle frame of the wearable electronic device movement to the housing, and the housing is made of a conductive material.

9. The housing according to claim 8, wherein the connection mechanism comprises a body and a spring, the body is fastened in the housing, a first end of the spring is connected to the body, and a second end of the spring cambers relative to the body to press against the metal middle frame.

10. The housing according to claim 9, wherein the body comprises a limiting mechanism located at the second end of the spring, the limiting mechanism limits a camber angle of the second end of the spring, the body is fastened in a mounting groove of the housing, the spring comprises a protrusion close to the second end, the protrusion is away from a direction of the body, and the protrusion protrudes from the mounting groove to press against the metal middle frame.

11. A wearable electronic device movement comprising a metal middle frame and a print circuit board (PCB) disposed on the metal middle frame, wherein:
at least one ground point is provided on the metal middle frame and is coupled to a ground port on the PCB;
at least one feed point is provided on the metal middle frame and is coupled to a radio frequency circuit on the PCB;
a connection mechanism is disposed on the metal middle frame; and
in response to that the wearable electronic device movement is mounted in mounting space of a housing, the connection mechanism electrically connects the metal middle frame to the housing, and the housing is made of a conductive material.

12. The wearable electronic device movement according to claim 11, wherein the connection mechanism comprises a body and a spring, the body is fastened in the metal middle frame, a first end of the spring is connected to the body, and a second end of the spring cambers relative to the body to press against the housing.

13. The wearable electronic device movement according to claim 12, wherein the body comprises a limiting mechanism located at the second end of the spring, the limiting mechanism limits a camber angle of the second end of the spring, the body is fastened in a mounting groove of the metal middle frame, the spring comprises a protrusion close to the second end, the protrusion is away from a direction of the body, and the protrusion protrudes from the mounting groove to press against the housing.

14. A wearable electronic device, comprising a housing and a wearable electronic device movement that is mounted inside mounting space of the housing, wherein:
the wearable electronic device movement comprises a metal middle frame and a printed circuit board (PCB) disposed on the metal middle frame;
a controller is disposed on the PCB;
at least one ground point is provided on the metal middle frame and is coupled to a ground port on the PCB;
at least one feed point is provided on the metal middle frame and is coupled to a radio frequency circuit on the PCB;
a connection mechanism is disposed inside the housing;
in response to that the wearable electronic device movement is mounted in mounting space of a housing, the controller is configured to obtain a switch control signal;
the controller is configured to control an ON state of at least one of a first switch or a second switch based on the switch control signal, the first switch being coupled between the at least one ground point and the ground port, the second switch being coupled between the at least one feed point and the radio frequency circuit;
the connection mechanism electrically connects a metal middle frame of the wearable electronic device movement to the housing; and
the housing is made of a conductive material.

15. The wearable electronic device according to claim 14, wherein the wearable electronic device further comprises a conductive adhesive or a conductive fabric, the conductive adhesive or the conductive fabric is located between the housing and a metal middle frame, and the housing is electrically connected to the metal middle frame through the conductive adhesive or the conductive fabric.

16. The wearable electronic device according to claim 14, wherein the controller is configured to generate the switch control signal in response to a selection signal triggered by a user based on a material of the housing.

17. The wearable electronic device according to claim 14, wherein the wearable electronic device movement further comprising: a proximity sensor chip, wherein the proximity sensor chip is coupled to the metal middle frame;
the proximity sensor chip is configured to detect a capacitance value of the metal middle frame; and
the controller is configured to generate the switch control signal based on the capacitance value.

18. The wearable electronic device according to claim 14, wherein the connection mechanism comprises a body and a spring, the body is fastened in the housing, a first end of the spring is connected to the body, and a second end of the spring cambers relative to the body to press against the metal middle frame.

19. The wearable electronic device according to claim 14, wherein a second connection mechanism is disposed on the metal middle frame; and in response to that the wearable electronic device movement is mounted in mounting space of a housing, the second connection mechanism electrically connects the metal middle frame to the housing, and the housing is made of a conductive material.

20. The wearable electronic device according to claim 14, wherein an impedance matching circuit is further disposed on the PCB, and the impedance matching circuit is connected between the metal middle frame and the ground port or the radio frequency circuit.
